(19) United States
(12) Patent Application Publication
(10) Pub. No.: US 2014/0247814 A1
(43) Pub. Date: Sep. 4, 2014

(54) METHODS AND APPARATUS FOR SPECIAL BURST TRANSMISSIONS TO REDUCE UPLINK AND DOWNLINK INTERFERENCE FOR TD-SCDMA SYSTEMS

(71) Applicants: Jianqiang Zhang, Beijing (CN); Jiming Guo, Beijing (CN); Mingxi Fan, San Diego, CA (US)

(72) Inventors: Jianqiang Zhang, Beijing (CN); Jiming Guo, Beijing (CN); Mingxi Fan, San Diego, CA (US)

(73) Assignee: QUALCOMM INCORPORATED, San Diegoo, CA (US)

(21) Appl. No.: 14/112,827

(22) PCT Filed: May 19, 2011
(86) PCT No.: PCT/CN2011/074306

§ 371 Date: May 21, 2014

(51) Int. Cl. H04W 52/04; H04L 5/00

(52) U.S. Cl. CPC H04W 52/04; H04L 5/0053
USPC 370/336

(57) ABSTRACT

A method and apparatus in wireless communications is provided. The method may include determining an occurrence of a special burst time slot, and obtaining one or more control symbols located in a first data field and a second data field of the special burst time slot.

### BACKGROUND

1. Field

The present application relates generally to wireless communications, and more specifically to methods and apparatus for configuring and detecting a special burst for reducing uplink and downlink interference in a Time Division Synchronous Code Division Multiple Access (TD-SCDMA) wireless communications system.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and TD-SCDMA. For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in relation to configuring and detecting a special burst for reducing uplink and downlink interference in a TD-SCDMA wireless communications system. According to one aspect, a method in wireless communications is provided. The method can comprise determining an occurrence of a special burst time slot. Further, the method can comprise obtaining one or more control symbols located in a first data field and a second data field of the special burst time slot.

Another aspect relates to an apparatus. The apparatus can include at least one processor configured to determine an occurrence of a special burst time slot, and obtain one or more control symbols located in a first data field and a second data field of the special burst time slot.

Another aspect relates to a computer program product comprising a computer-readable medium. The computer-readable medium comprising code executable to determine an occurrence of a special burst time slot. Further, the computer-readable medium comprises code executable to one or more control symbols located in a first data field and a second data field of the special burst time slot.

Yet another aspect relates to an apparatus. The apparatus can comprise means for determining an occurrence of a special burst time slot. Further, the apparatus can comprise means for obtaining one or more control symbols located in a first data field and a second data field of the special burst time slot.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 depicts a block diagram of an example telecommunications system, according to an aspect;

FIG. 2 depicts an example frame structure in a telecommunications system, according to an aspect;

FIG. 3 depicts an example TD-SCDMA based telecommunications system with multiple UEs communicating with a Node B, as time progresses, according to an aspect;

FIG. 4 depicts an example special burst frame structure, according to an another aspect;

FIG. 5 depicts another example special burst frame structure, according to an another aspect;

FIG. 6 depicts yet another example special burst frame structure, according to an another aspect;

FIG. 7 depicts an example flowchart of a methodology for receiving a data frame comprising a special burst at a UE, according to an aspect;

FIG. 8 depicts another example flowchart of a methodology for scheduling an UL transmission at a UE, according to an aspect;

FIG. 9 depicts another example flowchart of a methodology for receiving a data frame comprising a special burst at a Node B, according to an aspect;

FIG. 10 depicts another example flowchart of a methodology for scheduling an UL transmission at a Node B, according to an aspect;

FIG. 11 depicts a block diagram of an example user equipment, according to an aspect;

FIG. 12 depicts a block diagram illustrating an example of a Node B in communication with a UE in a telecommunications system, according to an aspect;

FIG. 13 depicts a block diagram of example components of the example user equipment in FIG. 11, according to an aspect; and

FIG. 14 depicts a block diagram of example components of the example Node B in FIG. 12, according to an aspect.

### DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

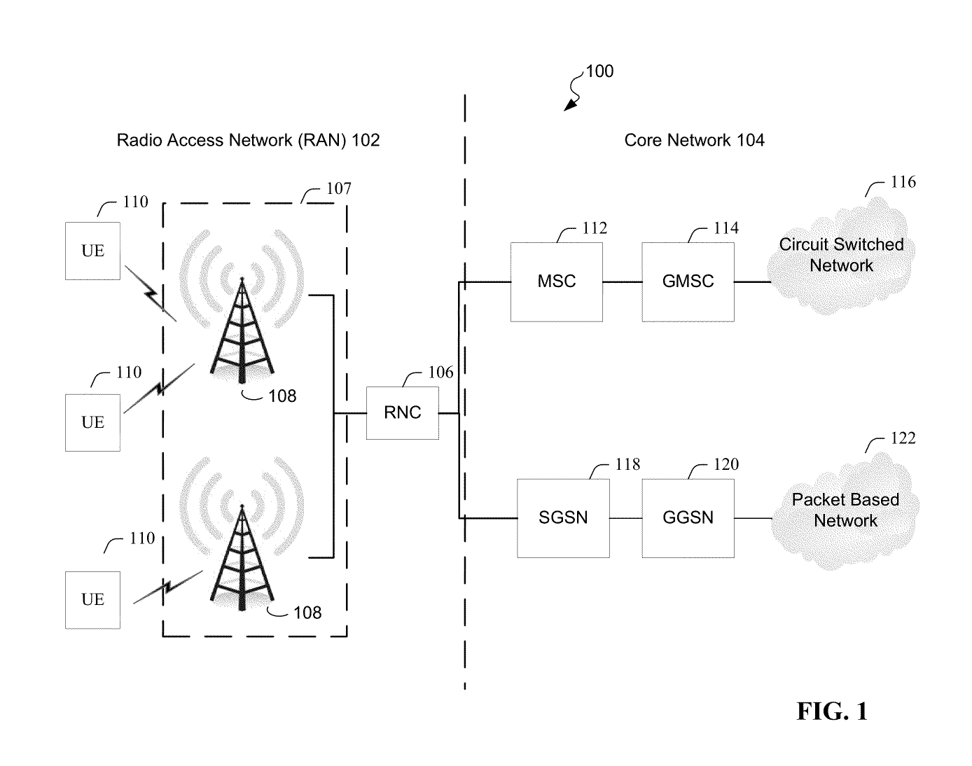

Referring to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a Radio Access Network (RAN) 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR may also be associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

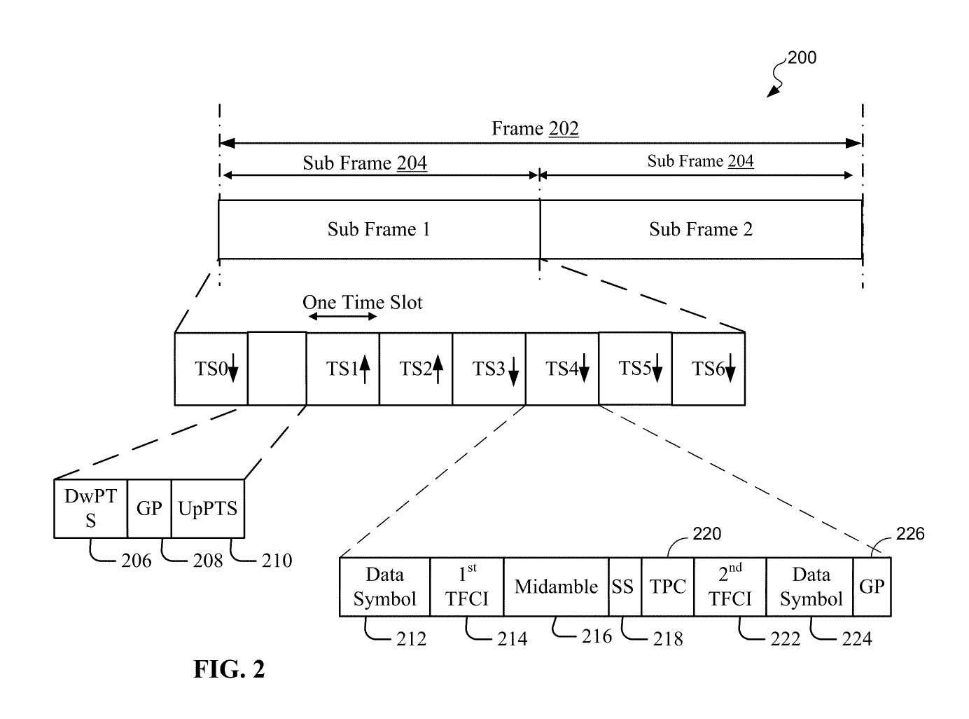

FIG. 2 shows a frame structure 200 for a TD-SCDMA carrier. The TD-SCDMA carrier, as illustrated, has a radio frame 202 that is 10 ms in length. The frame 202 has two 5 ms subframes 204, and each of the subframes 204 may include seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. In some examples, DwPTS is a time slot that may include 64 chips of synchronization symbols (SYNC) and 64 chips of GP for downlink Pilot and downlink synchronization (SCH). GP may comprise a time slot including about 163 chips of guard period at Tx and Rx switching point. UpPTS may be a time slot including 48 chips of SYNC1 and 32 chips of GP for uplink pilot and closed loop uplink synchronization (SCH).

Each time slot, TS0-TS6, may allow data transmission multiplexed on a maximum of 16 code channels. Data transmission on a code channel may use different frame structure for each time slot. In an example time slot TS4 shown in FIG. 2, a time slot may include a first data symbol 212, a first Transport Format Combination Indicator (TFCI) 214, a Midamble 216, a Synchronization Shift (SS) symbol 218, a Transmit Power Control (TPC) symbol 220, a second TFCI 222, a second data symbol 224, and a GP 226. In some other examples, a time slot may include two data symbols separated by a Midamble and followed by a GP (not shown). The Midamble 216 may be used for features, such as channel estimation, while the GP 208 and 226 may be used to avoid inter-burst interference.

In some implementations, open loop uplink synchronization procedures may be performed when a UE is powered on and starts to search the first 4 strongest SYNC sequences from nearby Node Bs and chooses the most suitable one to access. In other words, the UE may initially seek the training sequence SYNC from Node Bs. Since the SYNC in DwPTS may be transmitted by the Node B with the specified Gold code sequences and with higher Tx power than other main downlink time slots, the SYNC may be easily recognized by the UE. Meanwhile, the UE may try to read the contents in Broadcast Channel (BCH) following DwPTS to find the RACH/FACH pairs (e.g., random access channel (RACH) in the uplink and the forward access channel (FACH) in the downlink) and their status, etc. In some examples, despite the fact that the UE can receive the downlink synchronization signal from a Node B at this moment, it may not be able to determine when to transmit and how to establish the uplink synchronization with other UEs, because its distance from the Node B is unknown. In this case, the UE may roughly estimate its next Tx time and Tx power level, according to the detected arrival time and power level of the received training sequence (e.g., SYNC) in DwPTS. The UE may randomly choose a SYNC1 sequence in UpPTS and a pair of RACH/FACH among the idle access channel pairs, and send the SYNC1 and access request on the RACH with the estimated Tx time and Tx power level.

Alternatively, in some examples, closed loop uplink synchronization procedures may be performed. The SYNC1 sequence following the GP time slot may be used in the UpPTS for uplink synchronization, and it is a known orthogonal Gold code sequence. In this period, UEs (e.g., up to 8 UEs) that wish to establish the uplink synchronization can transmit with different Gold code sequences followed by RACHs while other code channels are in their EMPTY period to avoid any interference to them. Assuming a Node B detects an output from one UE, or has found the correlated peak value exceeding the minimum threshold, the SS and TPC commands may be obtained by comparing the detected arrival time and power level of the SYNC1 with the expected arrival time and power level. Meanwhile, the Node B may try to de-spread the signals in the following RACH. If the following data frame contents are verified to be correct by the cyclic redundancy check (CRC) and other methods, the Node B may respond to the UE by sending its control signaling over the chosen FACH in subsequent subframes. The control signaling includes the packets of higher layer signaling and assigned traffic channel information, and the fields of physical layer signaling such as SS and TPC, etc. Once the UE receives the these control signaling in the FACH, its access request has been accepted by the Node B. Meanwhile, the UE may need to adjust its Tx time and Tx power level according to the received SS and TPC information, and then continue its access procedures in the same RACH/FACH pair of the next subframe.

Further, the TPC command plays an important role in inner loop power control (also known as fast closed loop power control) in the uplink, where the UE transmitter may adjust its output power in accordance with one or more TPC commands received in DL transmission from, e.g., a Node B, in order to keep the received uplink Signal-to-Noise Ratio (SNR) at a given SNR target. The UE transmitter may be configured to change the output power with a step size of 1, 2 and 3 dB, in the time slot immediately after the TPC can be derived. Node Bs may estimate SNR of the received uplink DPCH, generate TPC commands and transmit the commands once per slot according to the following rule: if SNRest>SNRtarget then issue TPC commands to decrease UE output power, while if SNRest<SNRtarget then issue TPC commands to increase UE output power. Upon reception of one or more TPC commands in a time slot, the UE derives a single TPC command for each slot, combining multiple TPC commands if more than one is received in a time slot. Two algorithms are usually supported by the UE for deriving a TPC command. Which algorithm is used is determined by a UE-specific higher-layer parameter. If a single TPC command is received, the power control step in a UE transmitter may modify its output power in response to the TPC command. However, when consecutive received TPCs (e.g., 5 TPCs) command “power down,” the UE reduces its transmit power by 1 dB. Accordingly, if consecutive received TPCs (e.g., 5 TPCs) command “power up,” the UE increases its transmit power by 1 dB. The transmit power of the downlink channels may be determined by the network. The power control step size can take four values: 0.5, 1, 1.5 or 2 dB. It is mandatory for UTRAN to support step size of 1 dB, while support of other step sizes is optional. The UE may generate TPC commands to affect the network transmit power by, e.g., sending the TPC commands in the TPC data field of the uplink Dedicated Physical Control Channel (DPCCH). Upon receiving the TPC commands UTRAN can adjust its downlink DPCCH or Dedicated Physical Data Channel (DPDCH) power accordingly.

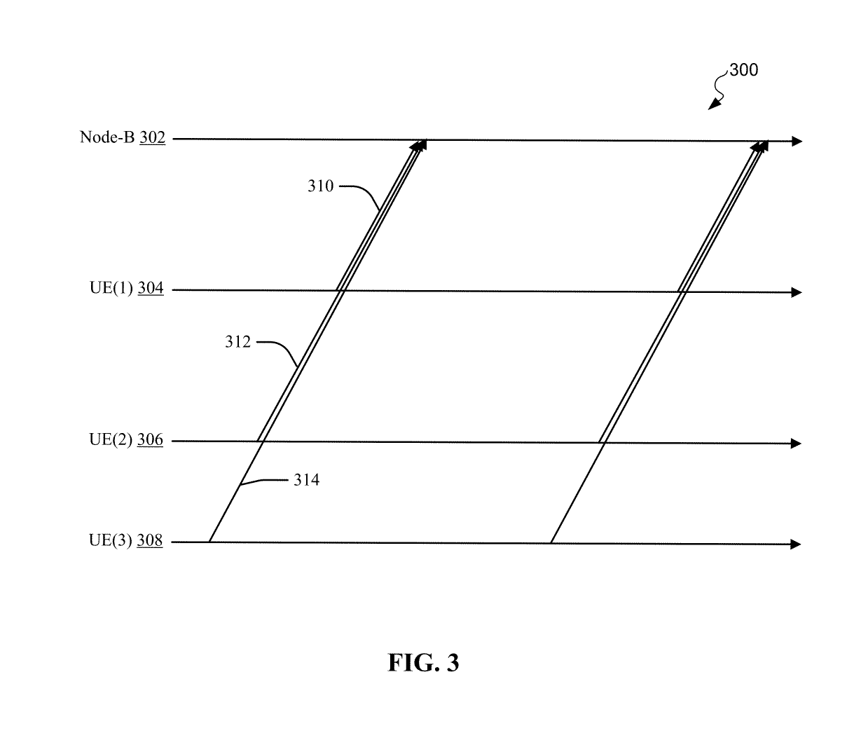

Turning now to FIG. 3, an example TD-SCDMA based system 300 with multiple UEs (304, 306, 308) communicating with a Node B 302, as time progresses, is illustrated. Generally, in TD-SCDMA systems, multiple UEs may share a common bandwidth in communication with a Node B 302. Additionally, one aspect in TD-SCDMA systems, as compared to CDMA and WCDMA systems, is UL synchronization. That is, in TD-SCDMA systems, different UEs (304, 306, 308) may synchronize on the uplink such that UEs (304, 306, 308) transmitted signals arrives at the Node B at approximately the same time. For example, in the depicted aspect, various UEs (304, 306, 308) are located at various distances from the serving Node B 302. Accordingly, in order for the UL transmission to reach the Node B 302 at approximately the same time, each UE may originate transmissions at different times. For example, UE 308 may be farthest from Node B 302 and may perform an UL transmission 314 before closer UEs. Additionally, UE 306 may be closer to Node B 302 than UE 308 and may perform an UL transmission 312 after UE 308. Similarly, UE 304 may be closer to Node B 302 than UE 306 and may perform an UL transmission 310 after UEs 306 and 308. The timing of the UL transmissions (310, 312, 314) may be such that the signals arrive at the Node B at approximately the same time.

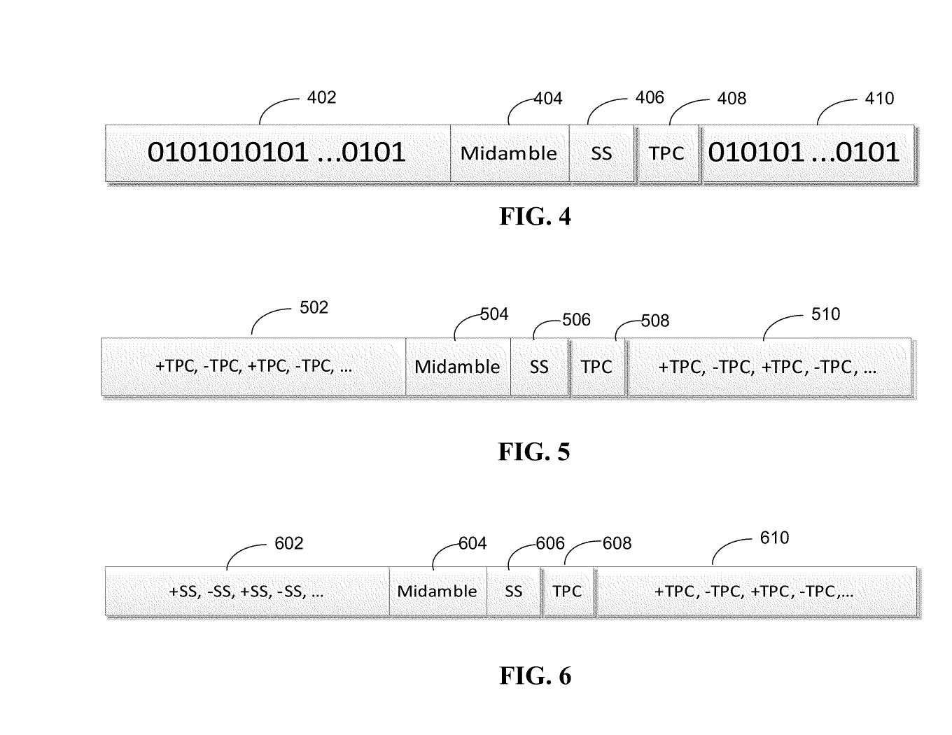

In TD-SCDMA, a special burst may be used in uplink and downlink transmissions for, e.g., maintaining uplink synchronization and downlink synchronization, inner-loop power control, and initial establishment and reconfiguration of various wireless communication devices. For Secondary Common Control Physical Channel (S-CCPCH), UL Dedicated Physical Channel (DPCH), DL DPCH, Physical Uplink Shared Channel (PUSCH) and Physical Downlink Shared Channel (PDSCH), special burst may employ the same timeslot format as the burst used for data provided by higher network layers (e.g., the format of TS4 depicted in FIG. 2). If the timeslot format of a special burst contains dedicated TFCI fields (e.g., 214 and 222 depicted in FIG. 2), the special burst may fill the TFCI fields with “0” bits. Special burst may also carry layer 1 control symbols such as TPC bits for the purposes of inner-loop power control. For example, in accordance with China Communication Standard Association standard (CCSA), the data symbol portions of a special burst (e.g., data symbols 214 and 226 in FIG. 2) can be filled with “0101 . . . 01” bit sequence with QPSK modulation. Further, for S-CCPCH, UL DPCH, DL DPCH, PUSCH and PDSCH, the transmission power of a special burst is the same as that of the data in substituted physical channel of the Coded Composite Transport Channel (CCTrCH). An example special burst according to CCSA standard is shown in FIG. 4, where the data symbol fields before and after Midamble code within one time slot are both filled with “0101 . . . 01,” except the positions of SS and TPC symbols. However, as the transmission power of special burst is the same as the power of the burst used for data provided by higher layers, the transmission of special burst may cause substantial interference in uplink and downlink data transmissions.

It is thus desirable to have the transmission power of special bursts reduced, such that the interference can be mitigated for both uplink and downlink data transmissions. However, reducing the transmission power of a special burst may adversely affect the SNR of the TPC and SS commands embedded therein. It is important to maintain the reliability of both the TPC and SS commands as the normal burst transmission for user data, because both commands are used for synchronization shift adjustment and inner-loop power.

In some implementations, turning now to FIG. 5, an example special burst for uplink transmission from, e.g., a UE to a Node B is proposed and illustrated. For uplink data transmissions, as SS command may not be useful, the data symbol fields before and after Midamble codes (e.g., 212 and 224 in FIG. 2) can be filled with repeated TPC symbols with alternating “+” and “−” signs except the positions of original TPC and SS commands. When Quadrature Phase Shift Keying (QPSK) modulation scheme is used, the TPC command may issue two bits “00” to command a power decrease of the transmitted signal, or two bits “11” to command a power increase of the transmitted signal. Similarly, if 8 Phase Shift Keying (8PSK) modulation scheme is used, the TPC command may issue three bits “000” or “111” to command a power decrease or increase of the transmitted signal, respectively. It is understood that different modulation schemes may be employed, and TPC command may use different bit sequence to command a power level change for a transmitted signal. However, when a bit sequence of zeros is used as zero-padding in certain data fields of a special burst, some confusion at Node B side may occur. To help eliminate this confusion, in some implementations of special burst transmission, the SS and TPC commands may be repeated with alternating positive (“+”) and minus (“−”) signs as shown in the FIGS. 5 and 6. For example, in FIG. 5, for an UL special burst transmission, bit sequence 00110011 . . . may be implemented in the first data symbol field 502 for TPC=00, and bit sequence 11001100 . . . in data symbol field 510 for TPC=11. This way, a reliable TPC command can be obtained for downlink power control at the Node B side. Furthermore, the SNR of this reliable TPC symbol can be used to, e.g., generate uplink power control command at the Node B side.

For downlink data transmissions, SS can be useful for synchronization shift adjustment at a UE side. Therefore, referring to FIG. 6, the first data field of a special burst may be filled with repeated SS symbols, and the second data field may be filled with repeated TPC symbols. Similar to the TPC command discussed in FIG. 5, bit sequence 00110011 . . . may be implemented in the first data symbol field 602 for SS=00, and bit sequence 11001100 . . . in the same data symbol field 602 for SS=11. In comparison to the special burst in FIG. 5, the number of repetitions for SS or TPC symbols in FIG. 6 is reduced nearly by half. As the repetition number can be up to 22 or 21 (assuming one spreading factor 16 code is employed), it seems a higher SNR of SS or TPC symbols can be obtained and SS and TPC can be reliably used for synchronization shift adjustment and inner-loop power control. Furthermore, the SNR of obtained TPC and SS symbols can further be used for, e.g., generating downlink power control command at the UE side.

As such, special burst can be transmitted at a reduced power level than that of a normal burst transmission for user data for both uplink and downlink transmissions without adversely affecting the reliability of both the SS and TPC commands. In addition, interference can also be mitigated.

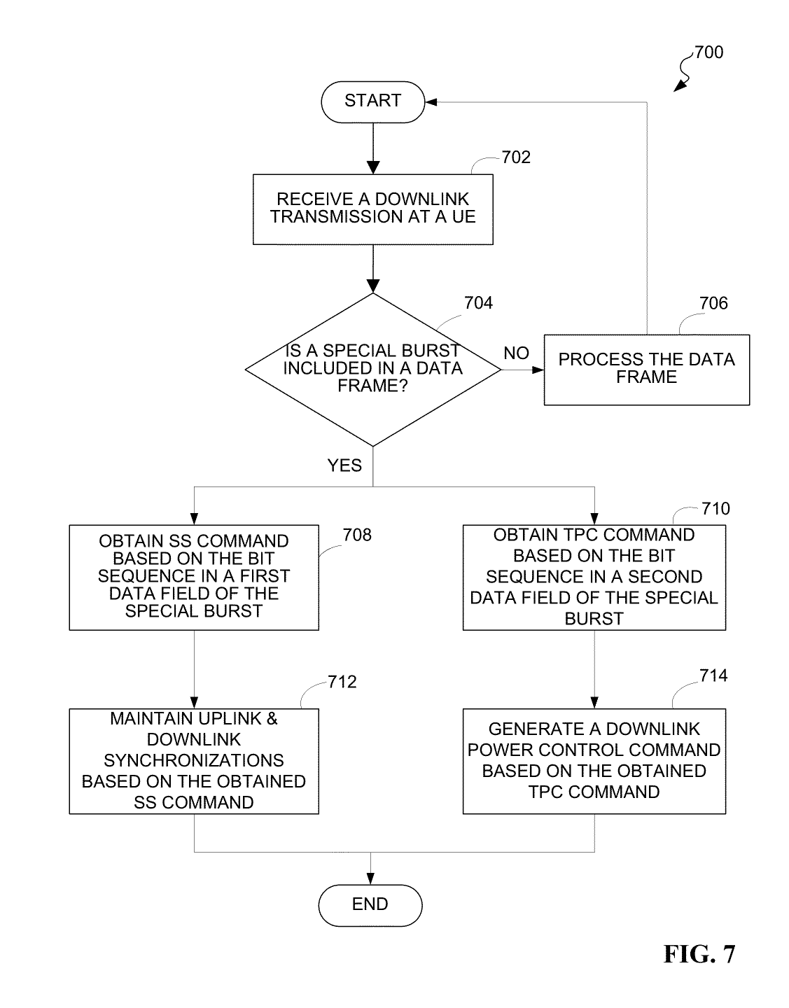

FIGS. 7-10 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be needed to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 is a flowchart 700 illustrating a DL data transmission at a UE side comprising a special burst time slot. Example operations may start at block 702 in which a UE receives a data frame from, e.g., a Node B, in a DL transmission. At block 704, the UE may determine whether a special burst resides in the received data frame. In one example aspect, where a special burst time slot is not detected or located, at block 706, the UE may process the received data frame and continue to detect special burst in each incoming DL data frame. Alternatively, when a special burst time slot is located in a DL transmission, the UE may obtain 708 a SS command based on the bit sequence in a first data field of the special burst (e.g., data symbol 610 in FIG. 6). Accordingly, a TPC command can be obtained 710 based on the bit sequence in a first data field of the special burst (e.g., data symbol 602 in FIG. 6). The obtained SS command can be used to maintain 712 uplink synchronization and downlink synchronization. Meanwhile, the obtained TPC command can be used to generate 714 a downlink power control command based on the obtained one or more control symbols.

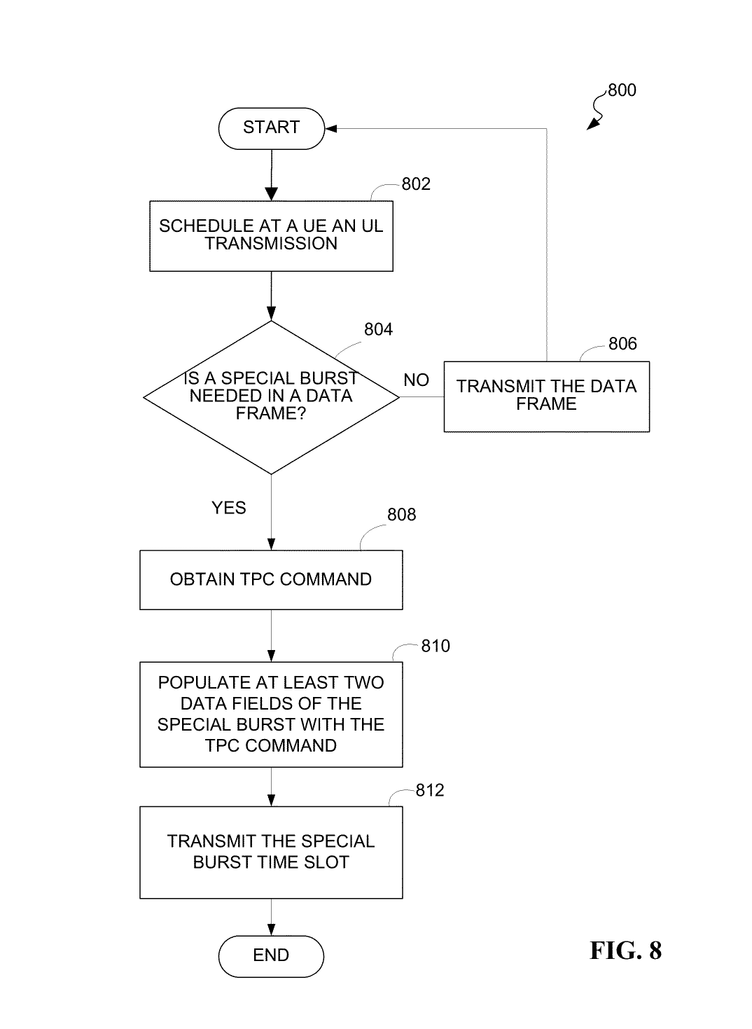

FIG. 8 is a flowchart 800 illustrating scheduling an UL transmission at a UE comprising a special burst time slot. Example operations may start at block 802 in which the UE determines and configures a data frame for an UL transmission. At block 804, a decision may be made at the UE side as to whether a special burst is to be included in the data frame. In some examples, a data frame may be transmitted 806 with no special burst. If a special burst is to be transmitted, the UE then obtains 808 TPC command and populates 810 at least a portion of the first data field (e.g., data symbol 502 in FIG. 5) and at least a portion of the second data field (e.g., data symbol 510 in FIG. 5) with the TPC command. For example, the TPC command may be repeated with alternating positive and negative signs in the at least two data symbol fields. As a result, a special burst time slot having a frame structure similar to the one shown in FIG. 5 may be transmitted 812 in an UL transmission from the UE to a Node B.

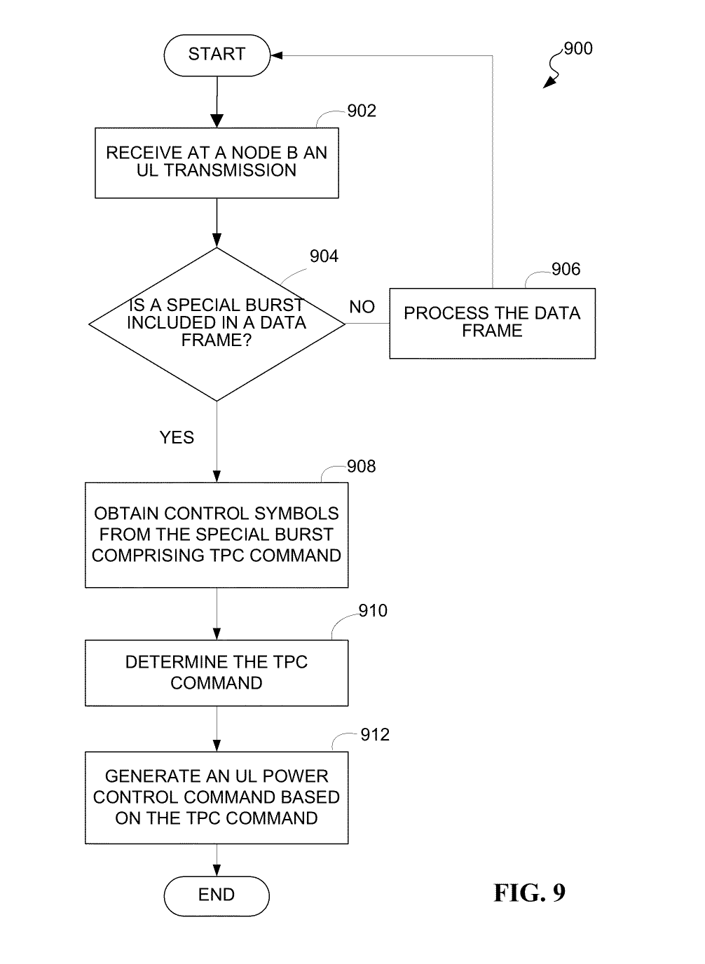

Further, FIG. 9 is a flowchart 900 illustrating receiving an UL data transmission at a Node B side comprising a special burst time slot. Example operations may start at block 902 in which a Node B receives a data frame from, e.g., a UE, in an UL transmission. In one aspect, where a special burst time slot is not detected and located, at block 906, the Node B may process the received data frame and continue to detect 904 whether a special burst presents in each incoming UL data frame. Alternatively, when a special burst time slot is located in an UL transmission, the Node B may obtain 908 one or more control symbols from the special burst comprising TPC command. That is, the TPC command may be determined 910 based on the bit sequence in a first data field (e.g., data symbol 502 in FIG. 5) and a second data field of the special burst (e.g., data symbol 510 in FIG. 5). This determination can be carried out with high reliability because, as disclosed above, the TPC command is configured to be repeated with alternating positive and negative signs in either of the data symbol fields. Accordingly, the obtained TPC command can be used to generate 912 an UL power control command at the Node B side.

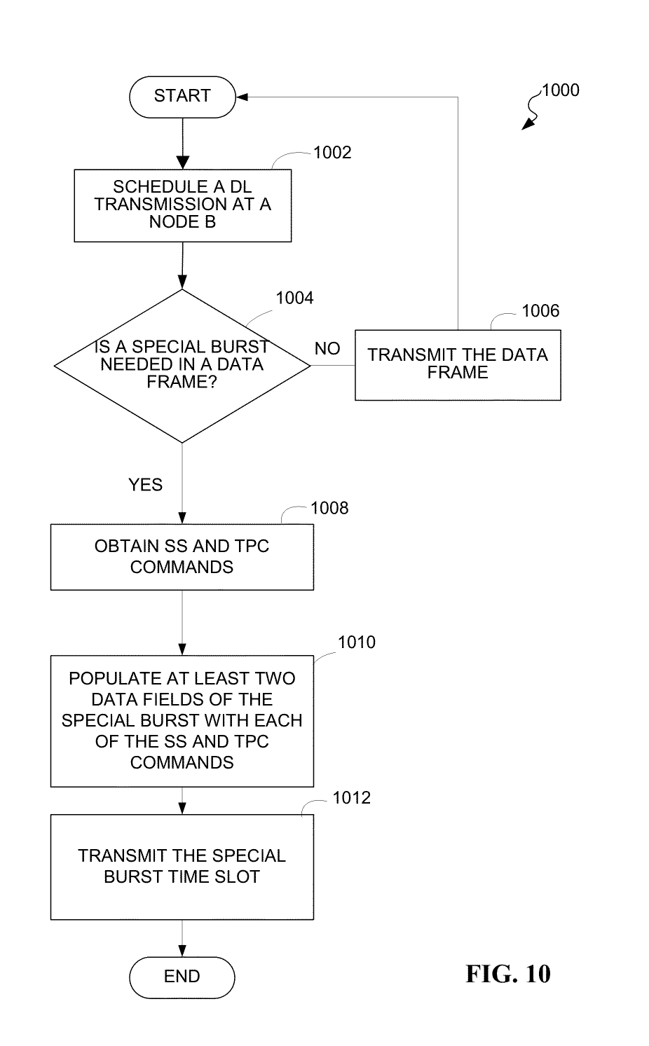

FIG. 10 is a flowchart 1000 illustrating a Node B scheduling a DL transmission comprising a special burst time slot. Example operations may start at block 1002 in which the Node B determines and configures a data frame for a DL transmission. At block 1004, a decision may be made as to whether a special burst is needed in the data frame. In some examples, a data frame may be transmitted 1006 with no special burst. If a special burst is to be transmitted, the Node B then obtains 1008 SS and TPC commands and populates 1010 at least a portion of the first data field (e.g., data symbol 602 in FIG. 6) with the SS command, and populate at least a portion of the second data field (e.g., data symbol 610 in FIG. 6) with the TPC command, respectively. For example, each of the SS and TPC command may be repeated with alternating positive and negative signs in each of the at least two data symbol fields. As a result, a special burst time slot having a frame structure similar to the one shown in FIG. 6 may be transmitted 1012 in a DL transmission from the Node B to a UE.

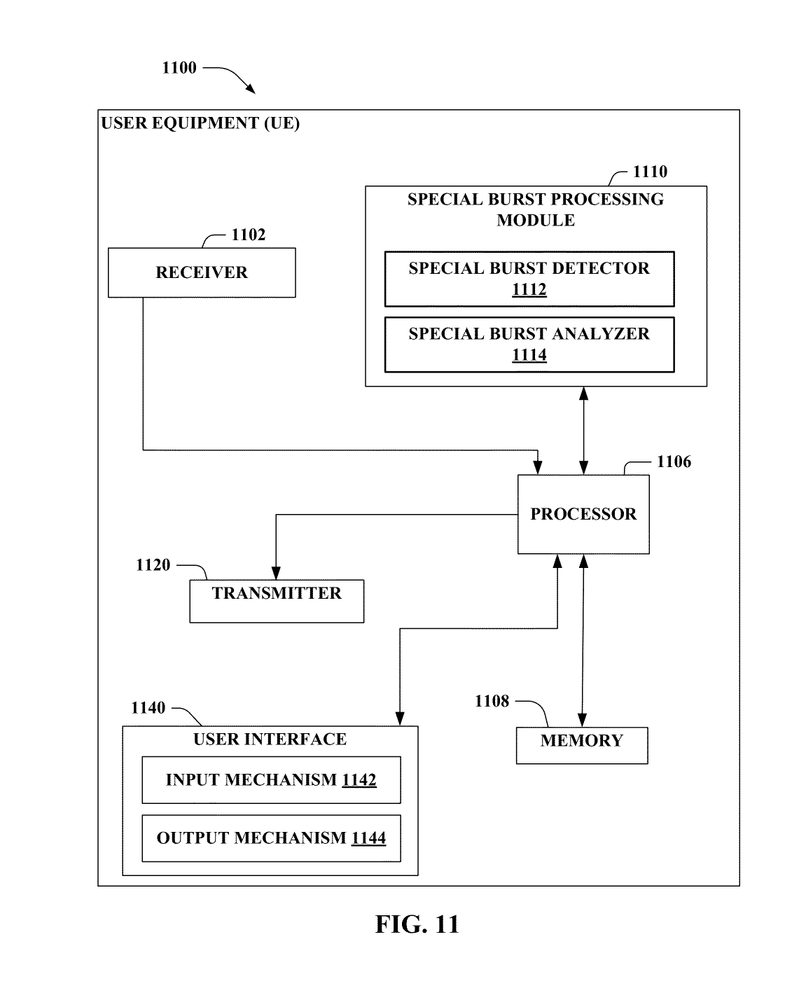

With reference now to FIG. 11, an illustration of a user equipment (UE) 1100 (e.g. a client device, wireless communications device (WCD) etc.) that facilitates uplink synchronization during random access procedures is presented. UE 1100 comprises receiver 1102 that receives one or more signal from, for instance, one or more receive antennas (not shown), performs typical actions on (e.g., filters, amplifies, downconverts, etc.) the received signal, and digitizes the conditioned signal to obtain samples. Receiver 1102 can further comprise an oscillator that can provide a carrier frequency for demodulation of the received signal and a demodulator that can demodulate received symbols and provide them to processor 1106 for channel estimation.

Processor 1106 can be a processor dedicated to analyzing information received by receiver 1102 and/or generating information for transmission by one or more transmitters 1120 (for ease of illustration, only one transmitter is shown), a processor that controls one or more components of UE 1100, and/or a processor that both analyzes information received by receiver 1102 and/or receiver 1152, generates information for transmission by transmitter 1120 for transmission on one or more transmitting antennas (not shown), and controls one or more components of UE 1100. In one aspect of UE 1100, processor 1106 may include at least one processor and memory, wherein the memory may be within the at least one processor 1106. By way of example and not limitation, the memory may include on-board cache or general purpose register.

UE 1100 can additionally comprise memory 1108 that is operatively coupled to processor 1106 and that can store data to be transmitted, received data, information related to available channels, data associated with analyzed signal and/or interference strength, information related to an assigned channel, power, rate, or the like, and any other suitable information for estimating a channel and communicating via the channel. Memory 1108 can additionally store protocols and/or algorithms associated with estimating and/or utilizing a channel (e.g., performance based, capacity based, etc.).

It will be appreciated that the data store (e.g., memory 1108) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 608 of the subject systems and methods is intended to comprise, without being limited to, these and any other suitable types of memory.

UE 1100 can further have a special burst processing module 1110 that assists the UE 1100 with special burst detection and analysis. In one aspect, special burst processing module 1110 may include a special burst detector 1112 to detect the presence of special burst in a data transmission. For example, the UE may include a receiver (e.g., a rake receiver) for receiving, a demodulator for demodulating the received DL data frame and producing a baseband signal. The baseband signal may be processed, such as by channel estimation device or circuitry and the data estimation circuitry, in the timeslots and with the appropriate codes assigned to the UE receiver. The channel estimation device can use the training sequence component in the baseband signal to provide channel information, such as channel impulse responses. The channel information may be used by the data estimation circuitry and a burst detector. The data estimation device can recover data from the channel by estimating soft symbols using the channel information. It is appreciated that a UE receiver may have multiple burst detectors to detect the reception of more than one code. Multiple burst detectors can be used, for example, when multiple CCTrCHs are directed towards one receiver. The UE may use the burst detector 1112 to determine whether there are any symbols within a particular communication channel by comparing the estimated noise power to the estimated signal power by using, e.g., a comparator. In one aspect, the determination may be made after a defined number of unsuccessful attempts have been performed.

The special burst processing module 1110 may also include a special burst analyzer 1114 for, e.g., coding or decoding a special burst time slot in a data frame. For example, the special burst analyzer 1114 may decode the received data using the channel impulse responses from the channel estimation statistics and a set of channelization codes and spreading codes. The special burst analyzer 1114 may also utilize any method to estimate the data symbols of the received communication by using e.g., a minimum mean square error block linear equalizer (MMSE-BLE), a zero-forcing block linear equalizer (ZF-BLE) and the like.

Additionally, UE 1100 may include user interface 1140. User interface 1140 may include input mechanisms 1142 for generating inputs into WCD 1100, and output mechanism 1142 for generating information for consumption by the user of wireless device 1100. For example, input mechanism 1142 may include a mechanism such as a key or keyboard, a mouse, a touch-screen display, a microphone, etc. Further, for example, output mechanism 1144 may include a display, an audio speaker, a haptic feedback mechanism, a Personal Area Network (PAN) transceiver etc. In the illustrated aspects, output mechanism 1144 may include a display operable to present content that is in image or video format or an audio speaker to present content that is in an audio format.

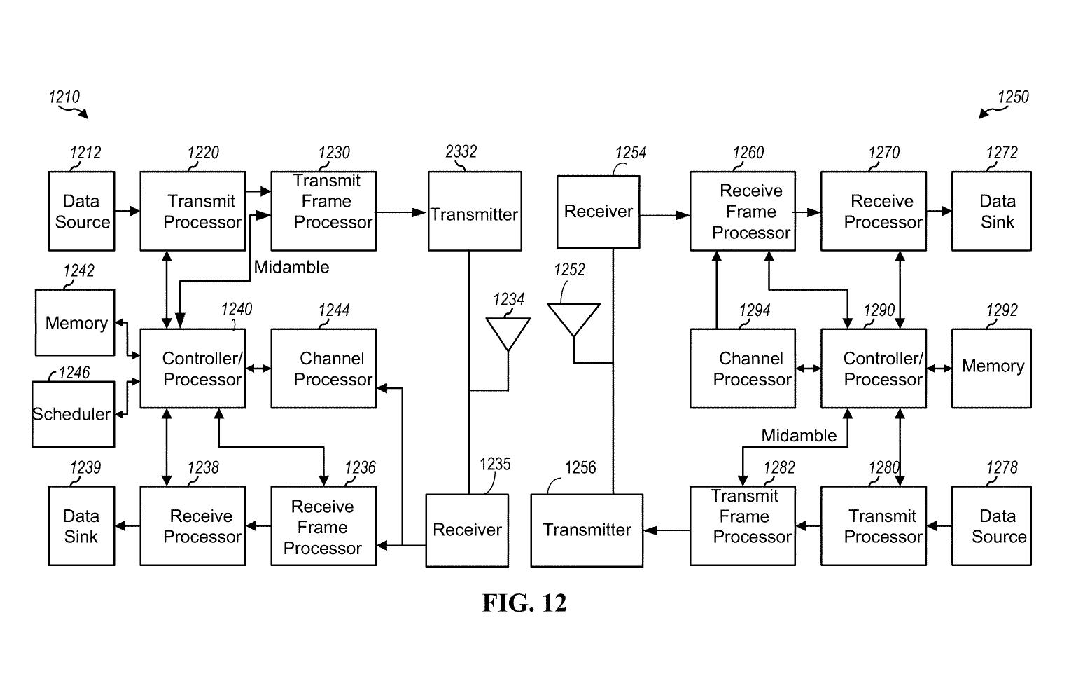

FIG. 12 is a block diagram of a Node B 1210 in communication with a UE 1250 in, e.g., the RAN 102 in FIG. 1, the Node B 1210 may be the Node B 108 in FIG. 1, and the UE 1250 may be the UE 110 in FIG. 1. In a DL communication, a transmit processor 1220 may receive data from a data source 1212 and control signals from a controller/processor 1240. The transmit processor 1220 provides various signal processing functions for the data and control signals, as well as reference signals (e.g., pilot signals). For example, the transmit processor 1220 may provide CRC codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1244 may be used by a controller/processor 1240 to determine the coding, modulation, spreading, and/or scrambling schemes for the transmit processor 1220. These channel estimates may be derived from a reference signal transmitted by the UE 350 or from feedback contained in the Midamble 216 (FIG. 2) from the UE 1250. The symbols generated by the transmit processor 1220 are provided to a transmit frame processor 1230 to create a frame structure. The transmit frame processor 330 creates this frame structure by multiplexing the symbols with a Midamble 214 (FIG. 2) from the controller/processor 1240, resulting in a series of frames. The frames are then provided to a transmitter 1232, which provides various signal conditioning functions including amplifying, filtering, and modulating the frames onto a carrier for downlink transmission over the wireless medium through smart antennas 1234. The smart antennas 1234 may be implemented with beam steering bidirectional adaptive antenna arrays or other similar beam technologies.

At the UE 1250, a receiver 1254 receives the downlink transmission through an antenna 1252 and processes the transmission to recover the information modulated onto the carrier. The information recovered by the receiver 1254 is provided to a receive frame processor 1260, which parses each frame, and provides the Midamble 216 (FIG. 2) to a channel processor 1294 and the data, control, and reference signals to a receive processor 1270. The receive processor 1270 then performs the inverse of the processing performed by the transmit processor 1220 in the Node B 1210. More specifically, the receive processor 1270 descrambles and de-spreads the symbols, and then determines the most likely signal constellation points transmitted by the Node B 1210 based on the modulation scheme. These soft decisions may be based on channel estimates computed by the channel processor 1294. The soft decisions are then decoded and deinterleaved to recover the data, control, and reference signals. The CRC codes are then checked to determine whether the frames were successfully decoded. The data carried by the successfully decoded frames will then be provided to a data sink 1272, which represents applications running in the UE 1250 and/or various user interfaces (e.g., display). Control signals carried by successfully decoded frames will be provided to a controller/processor 1290. When frames are unsuccessfully decoded by the receiver processor 1270, the controller/processor 1290 may also use an acknowledgement (ACK) and/or negative acknowledgement (NACK) protocol to support retransmission requests for those frames.

In the uplink, data from a data source 1278 and control signals from the controller/processor 1290 are provided to a transmit processor 1280. The data source 1278 may represent applications running in the UE 1250 and various user interfaces (e.g., keyboard). Similar to the functionality described in connection with the downlink transmission by the Node B 1210, the transmit processor 1280 provides various signal processing functions including CRC codes, coding and interleaving to facilitate FEC, mapping to signal constellations, spreading with OVSFs, and scrambling to produce a series of symbols. Channel estimates, derived by the channel processor 1294 from a reference signal transmitted by the Node B 1210 or from feedback contained in the Midamble transmitted by the Node B 1210, may be used to select the appropriate coding, modulation, spreading, and/or scrambling schemes. The symbols produced by the transmit processor 1280 will be provided to a transmit frame processor 1282 to create a frame structure. The transmit frame processor 1282 creates this frame structure by multiplexing the symbols with a Midamble 216 (FIG. 2) from the controller/processor 390, resulting in a series of frames. The frames are then provided to a transmitter 1256, which provides various signal conditioning functions including amplification, filtering, and modulating the frames onto a carrier for uplink transmission over the wireless medium through the antenna 1252.

The uplink transmission is processed at the Node B 1210 in a manner similar to that described in connection with the receiver function at the UE 1250. A receiver 1235 receives the uplink transmission through the antenna 1234 and processes the transmission to recover the information modulated onto the carrier. The information recovered by the receiver 1235 is provided to a receive frame processor 1236, which parses each frame, and provides the Midamble 216 (FIG. 2) to the channel processor 1244 and the data, control, and reference signals to a receive processor 1238. The receive processor 1238 performs the inverse of the processing performed by the transmit processor 1280 in the UE 1250. The data and control signals carried by the successfully decoded frames may then be provided to a data sink 1239 and the controller/processor, respectively. If some of the frames were unsuccessfully decoded by the receive processor, the controller/processor 1240 may also use an acknowledgement (ACK) and/or negative acknowledgement (NACK) protocol to support retransmission requests for those frames.

The controller/processors 1240 and 1290 may be used to direct the operation at the Node B 1210 and the UE 1250, respectively. For example, the controller/processors 1240 and 1290 may provide various functions including timing, peripheral interfaces, voltage regulation, power management, and other control functions. The computer readable media of memories 1242 and 1292 may store data and software for the Node B 1210 and the UE 1250, respectively. A scheduler/processor 1246 at the Node B 1210 may be used to allocate resources to the UEs and schedule downlink and/or uplink transmissions for the UEs.

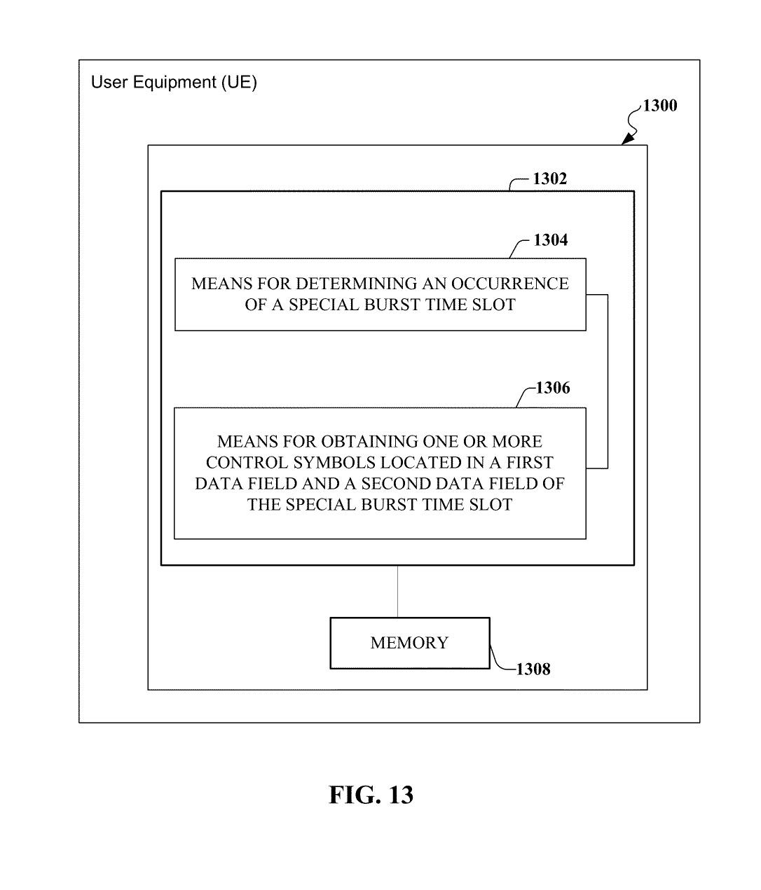

Referring to FIG. 13, an apparatus 1300 which includes functional blocks representing functions implemented by a processor, software, or combination thereof (e.g., firmware) can reside at least partially within a UE. As such, apparatus 1300 includes a logical grouping 1302 of electrical components that can act in conjunction. For instance, logical grouping 1302 can include means for determining an occurrence of a special burst time slot (Block 1304). For example, in an aspect, the means 1304 can include the special burst detector 1112 and/or processor 1106 of UE 1100 in FIG. 11. Further, logical grouping 1302 can include means for obtaining one or more control symbols located in a first data field and a second data field of the special burst time slot (Block 1306). For example, in an aspect, the means 1306 can include the special burst analyzer 1114 and/or processor 1106 of UE 1100 in FIG. 11. Also, logical grouping 1302 can include means for means for receiving, at the UE, the occurrence of the special burst time slot (e.g., receiver 1102 and/or processor 1106 of UE 1100 in FIG. 11). Logical grouping 1302 can further include means for generating a downlink power control command based on the obtained one or more control symbols, and means for maintaining uplink synchronization and downlink synchronization based on the obtained SS command (e.g., the special burst analyzer 1114 and/or processor 1106 of UE 1100 in FIG. 11). Logical grouping 1302 can include means for transmitting the special burst time slot. For example, in an aspect, the means 1306 can include, e.g., transmitter 1120 and/or processor 1106 of UE 1100 in FIG. 11.

Additionally, apparatus 1300 can include a memory 1308 that retains instructions for executing functions associated with electrical components 1304, 1306, and 1308. While shown as being external to memory 1308, it is to be understood that one or more of electrical components 1304, 1306, and 1308 can exist within memory 1308. While shown as being external to memory 1308, it is to be understood that one or more of the means 1304 and 1306 can exist within memory 1308.

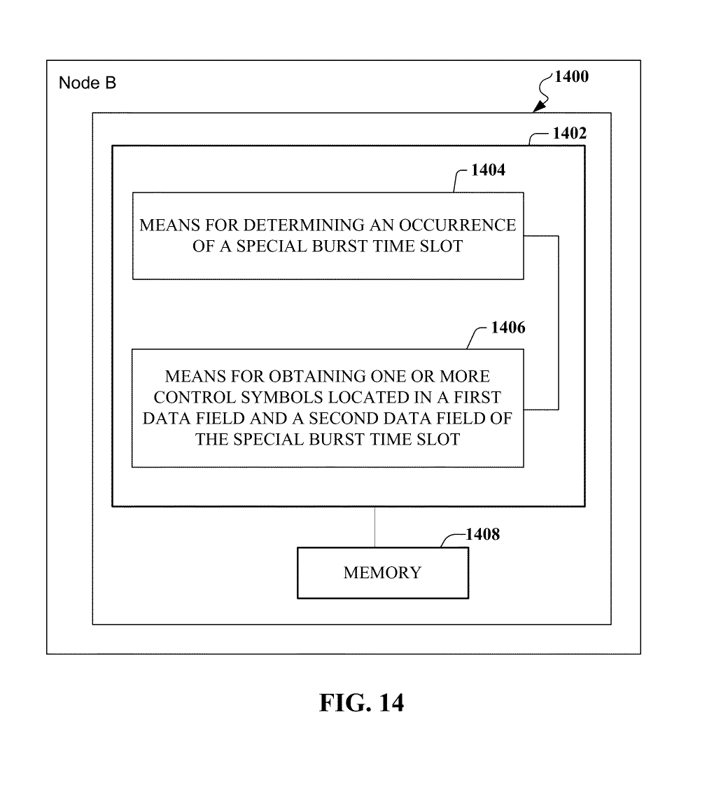

Referring to FIG. 14, an apparatus 1400 which includes functional blocks representing functions implemented by a processor, software, or combination thereof (e.g., firmware) can reside at least partially within a UE. As such, apparatus 1300 includes a logical grouping 1402 of electrical components that can act in conjunction. For instance, logical grouping 1402 can include means for determining an occurrence of a special burst time slot (Block 1404). For example, in an aspect, the means 1404 can include, e.g., receiver 1235 and receive processor 1238 of Node B 1210 in FIG. 12. Further, logical grouping 1402 can include means for obtaining one or more control symbols located in a first data field and a second data field of the special burst time slot (Block 1406). For example, in an aspect, the means 1406 can include, e.g., controller/processor 1240 of Node B 1210 in FIG. 12. Also, logical grouping 1402 can include means for generating an uplink power control command based on the obtained TPC command, and means for transmitting the special burst time slot. For example, in an aspect, the means 1406 can include, e.g., transmit frame processor 1230 and transmitter 1232 of Node B 1210 in FIG. 12.

Additionally, apparatus 1400 can include a memory 1408 that retains instructions for executing functions associated with electrical components 1404, 1406, and 1408. While shown as being external to memory 1408, it is to be understood that one or more of electrical components 1404, 1406, and 1408 can exist within memory 1408. While shown as being external to memory 1408, it is to be understood that one or more of the means 1404 and 1406 can exist within memory 1408.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logic blocks, modules and circuits described in connection with the present disclosure may be implemented or performed with a general purpose processor, a digital signal processor (DSP), an application specific integrated circuit (ASIC), a field programmable gate array signal (FPGA) or other programmable means device (PLD), discrete gate or transistor means, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The steps disclosed in the example algorithms may be interchanged in their order without departing from the scope and spirit of the present disclosure. Also, the steps illustrated in the example algorithms are not exclusive and other steps may be included or one or more of the steps in the example algorithms may be deleted without affecting the scope and spirit of the present disclosure.

The methods disclosed herein comprise one or more steps or actions for achieving the described method. The method steps and/or actions may be interchanged with one another without departing from the scope and spirit of the present disclosure. The method steps and/or actions are not exclusive and other method steps and/or actions may be included or one or more method steps and/or actions may be deleted without affecting the scope and spirit of the present disclosure. In other words, unless a specific order of steps or actions is specified, the order and/or use of specific steps and/or actions may be modified without departing from the scope and spirit of the disclosure.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

While various aspects of the present disclosure have been described herein, each with one or more technical features, those skilled in the art will appreciate that different technical features of the various aspects described herein may also be combined resulting in various combinations not explicitly described herein. Further, certain aspects may involve multiple technical features, one or more of which may be omitted, again resulting in various combinations of one or more technical features not explicitly described herein.

As an example, while certain aspects may provide a method (and corresponding apparatus) for wireless communications generally including determining an occurrence of a special burst time slot; and obtaining one or more control symbols located in a first data field and a second data field of the special burst time slot, exactly how the receiving and determining is performed may vary according to different aspects.

It is to be understood that the claims are not limited to the precise configuration and components illustrated above. Various modifications, changes and variations may be made in the arrangement, operation and details of the methods and apparatus described above without departing from the scope and spirit of the present disclosure.

What is claimed is:

1. A method in wireless communications, comprising:
determining an occurrence of a special burst time slot; and
obtaining one or more control symbols located in a first data field and a second data field of the special burst time slot.

2. The method of claim 1, wherein the one or more control symbols comprise at least one of a Synchronization Shift (SS) command and a Transmit Power Control (TPC) command.

3. The method of claim 1, wherein the one or more control symbols are located in the first data field and the second data field with alternating positive and negative signs.

4. The method of claim 1, wherein the obtaining further comprises receiving, at a user equipment (UE), the occurrence of the special burst time slot; and
further comprising generating a downlink power control command based on the obtained one or more control symbols.

5. The method of claim 1, wherein the obtaining further comprises receiving, at a UE, the occurrence of the special burst time slot, and wherein the one or more control symbols comprise a SS command; and
further comprising maintaining uplink synchronization and downlink synchronization based on the obtained SS command.

6. The method of claim 1, wherein the obtaining comprises:
receiving, at a Node B, the occurrence of the special burst time slot, and wherein the one or more control symbols comprise a TPC command; and
further comprising generating an uplink power control command based on the obtained TPC command.

7. The method of claim 1, wherein the one or more control symbols comprise a TPC command, wherein the obtaining comprises populating, at a UE, at least a portion of the first data field and at least a portion of the second data field with the TPC command; and
further comprising transmitting the special burst time slot.

8. The method of claim 7, wherein the transmitting further comprises transmitting the special burst time slot at a transmit power that is reduced in comparison to a transmit power used for a non-special burst time slot.

9. The method of claim 1, wherein the one or more control symbols comprise a SS command and a TPC command, wherein the obtaining comprises populating, at a Node B, at least a portion of the first data field with the SS command and populating at least a portion of the second data field with the TPC command; and
further comprising transmitting the special burst time slot.

10. The method of claim 1, wherein the at least one special burst time slot comprises a first transport format combination indicator (TFCI) data field, and wherein a portion of the first and second data field that does not include the one or more control symbols is populated with zeros.

11. An apparatus for wireless communications, comprising:
at least one processor configured to:
determine an occurrence of a special burst time slot; and
obtain one or more control symbols located in a first data field and a second data field of the special burst time slot.

12. The apparatus of claim 11, wherein the one or more control symbols comprise at least one of a Synchronization Shift (SS) command and a Transmit Power Control (TPC) command.

13. The apparatus of claim 11, wherein the one or more control symbols are located in the first data field and the second data field with alternating positive and negative signs.

14. The apparatus of claim 11, wherein the at least one processor is further configured to:
receive, at a user equipment (UE), the occurrence of the special burst time slot; and
generate a downlink power control command based on the obtained one or more control symbols.

15. The apparatus of claim 11, wherein the at least one processor is further configured to:
receive, at a UE, the occurrence of the special burst time slot, and wherein the one or more control symbols comprise a SS command; and
maintain uplink synchronization and downlink synchronization based on the obtained SS command.

16. The apparatus of claim 11, wherein the at least one processor is further configured to:
receive, at a Node B, the occurrence of the special burst time slot, and wherein the one or more control symbols comprise a TPC command; and
generate an uplink power control command based on the obtained TPC command.

17. The apparatus of claim 11, wherein the one or more control symbols comprise a TPC command, and wherein the at least one processor is further configured to:
populate, at a UE, at least a portion of the first data field and at least a portion of the second data field with the TPC command; and
transmit the special burst time slot.

18. The apparatus of claim 17, wherein the transmitting further comprises transmitting the special burst time slot at a transmit power that is reduced in comparison to a transmit power used for a non-special burst time slot.

19. The apparatus of claim 11, wherein the one or more control symbols comprise a SS command and a TPC command, and
wherein the at least one processor is further configured to:
populate, at a Node B, at least a portion of the first data field with the SS command and populating at least a portion of the second data field with the TPC command; and
transmit the special burst time slot.

20. The apparatus of claim 11, wherein the at least one special burst time slot comprises a first transport format combination indicator (TFCI) data field, and wherein a portion of the first and second data field that does not include the one or more control symbols is populated with zeros.

21. A computer program product, comprising:
a computer-readable medium comprising code for:
determining an occurrence of a special burst time slot; and
obtaining one or more control symbols located in a first data field and a second data field of the special burst time slot.

22. The computer program product of claim 21, wherein the one or more control symbols comprise at least one of a Synchronization Shift (SS) command and a Transmit Power Control (TPC) command.

23. The computer program product of claim 21, wherein the one or more control symbols are located in the first data field and the second data field with alternating positive and negative signs.

24. The computer program product of claim 21, wherein the obtaining further comprises receiving, at a user equipment (UE), the occurrence of the special burst time slot; and
further comprising generating a downlink power control command based on the obtained one or more control symbols.

25. The computer program product of claim 21, wherein the obtaining further comprises receiving, at a UE, the occurrence of the special burst time slot, and wherein the one or more control symbols comprise a SS command; and
further comprising maintaining uplink synchronization and downlink synchronization based on the obtained SS command.

26. The computer program product of claim 21, wherein the obtaining comprises:
receiving, at a Node B, the occurrence of the special burst time slot, and wherein the one or more control symbols comprise a TPC command; and
further comprising generating an uplink power control command based on the obtained TPC command.

27. The computer program product of claim 21, wherein the one or more control symbols comprise a TPC command, wherein the obtaining comprises populating, at a UE, at least a portion of the first data field and at least a portion of the second data field with the TPC command; and
further comprising transmitting the special burst time slot.

28. The computer program product of claim 27, wherein the transmitting further comprises transmitting the special burst time slot at a transmit power that is reduced in comparison to a transmit power used for a non-special burst time slot.

29. The computer program product of claim 21, wherein the one or more control symbols comprise a SS command and a TPC command, wherein the obtaining comprises populating, at a Node B, at least a portion of the first data field with the SS command and populating at least a portion of the second data field with the TPC command; and
further comprising transmitting the special burst time slot.

30. The computer program product of claim 21, wherein the at least one special burst time slot comprises a first transport format combination indicator (TFCI) data field, and wherein a portion of the first and second data field that does not include the one or more control symbols is populated with zeros.

31. An apparatus for wireless communications, comprising:
means for determining an occurrence of a special burst time slot; and
means for obtaining one or more control symbols located in a first data field and a second data field of the special burst time slot.

32. The apparatus of claim 31, wherein the one or more control symbols comprise at least one of a Synchronization Shift (SS) command and a Transmit Power Control (TPC) command.

33. The apparatus of claim 31, wherein the one or more control symbols are located in the first data field and the second data field with alternating positive and negative signs.

34. The apparatus of claim 31, wherein the means for obtaining further comprises means for receiving, at a user equipment (UE), the occurrence of the special burst time slot; and
further comprising means for generating a downlink power control command based on the obtained one or more control symbols.

35. The apparatus of claim 31, wherein the means for obtaining further comprises means for receiving, at a UE, the occurrence of the special burst time slot, and wherein the one or more control symbols comprise a SS command; and
further comprising means for maintaining uplink synchronization and downlink synchronization based on the obtained SS command.

36. The apparatus of claim 31, wherein the means for obtaining comprises means for receiving, at a Node B, the occurrence of the special burst time slot, and wherein the one or more control symbols comprise a TPC command; and
further comprising means for generating an uplink power control command based on the obtained TPC command.

37. The apparatus of claim 31, wherein the one or more control symbols comprise a TPC command, wherein the means for obtaining comprises means for populating, at a UE, at least a portion of the first data field and at least a portion of the second data field with the TPC command; and
further comprising means for transmitting the special burst time slot.

38. The apparatus of claim 37, wherein the means for transmitting further comprises means for transmitting the special burst time slot at a transmit power that is reduced in comparison to a transmit power used for a non-special burst time slot.

39. The apparatus of claim 31, wherein the one or more control symbols comprise a SS command and a TPC command, wherein the means for obtaining comprises means for populating, at a Node B, at least a portion of the first data field with the SS command and populating at least a portion of the second data field with the TPC command; and
further comprising means for transmitting the special burst time slot.

40. The apparatus of claim 31, wherein the at least one special burst time slot comprises a first transport format combination indicator (TFCI) data field, and wherein a portion of the first and second data field that does not include the one or more control symbols is populated with zeros.
